(19) United States
(12) Patent Application Publication
(10) Pub. No.: US 2010/0038169 A1
(43) Pub. Date: Feb. 18, 2010

(54) COMPOSITE MATERIALS FOR ABSORBING SOUND MADE FROM POLYESTER OF HIGH DENSITY AND METHOD FOR PREPARATION THEREOF

(76) Inventor: Kye Jeong Lee, Gwangju (KR)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/447,195

(22) PCT Filed: Oct. 23, 2007
(86) PCT No.: PCT/KR2007/005205

§ 371 Date: Apr. 24, 2009

(30) Foreign Application Priority Data
Oct. 24, 2006 (KR) 20-2006-0028323

(51) Int. Cl. E04B 1/84; B32B 37/00

(52) U.S. Cl. 181/294; 156/538

(57) ABSTRACT

A high-density sound-absorbing composite material is made from polyester. The sound-absorbing composite material is comprised of a porous sound-absorbing base material which is based on composite polyester fiber materials and having a density of from 150 kg/D to 350 kg/D and a synthetic resin sheet that is attached to one side of the base material. In addition, an apparatus is provided for producing a high-density sound-absorbing composite material made from polyester, wherein by using the apparatus, a synthetic resin sheet is adhered to the high-density and porous sound-absorbing base material which is based on composite polyester fiber materials. The apparatus is characterized by mechanisms for: (1) inserting sound-absorbing base materials between on a flat working board and under the sheet while the revolution speed of a supporting roller on which the sheet is wound is being controlled, (2) fixing both corners of the sheet by pulling them to make the sheet align with the edge of the sound-absorbing base material, and (3) adhering the sheet tightly to the sound-absorbing base material by rotational motion of the roller. As a result, by blocking air flow through a wall face while maintaining porosity for soundproofing (sound-absorbing) effect of a sound-absorbing plate, an adsorption by dust, etc. can be prevented.

### TECHNICAL FIELD

The present invention relates to high-density sound-absorbing composite materials made from polyester. Specifically, an illustrative embodiment of the present invention relates to sound-absorbing composite materials, wherein a sheet of synthetic resin is applied on one side of a high-density sound-absorbing basic material made from polyester and a fluorochemical is coated on the other side of the basic material to provide sound-absorbing composite materials having an excellent anti-contaminating property and improved workability.

### BACKGROUND

In accordance with industrial developments, use of various industrial machineries inevitably yields undesirable noise problems and other noises occurring in everyday life such as noise between floors of apartments, which is now the most typical housing form for modern people, is more serious than ever before. As such, in order to solve such problems associated with various noises, many proposals have been made.

Until now, various sound-absorbing materials have been used as a way for preventing noises. Such sound-absorbing materials include, for example, (i) felt prepared from regenerated fiber using a thermoplastic binder (e.g., phenol resin), (ii) molded felt prepared by using a thermoplastic binder (e.g., polyethylene and polypropylene resin), (iii) other molded felt prepared by adding thermoplastic fiber as a binder, (iv) sound-absorbing materials prepared by heat pressing or cold pressing inorganic fiber materials comprising thermosetting or thermoplastic resin (e.g., glass fiber), (v) sponge type sound-absorbing materials wherein polyurethane, etc. are processed into a foam state, and (vi) sound-absorbing materials prepared from a blend of main fiber (e.g., polyester fiber) and binding fiber which has a lower melting point than that of the main fiber.

The above-described fiber based sound-absorbing materials are produced by overlapping fiber blends that are evenly arranged by carding machine, molding them with needle punching or chemical binder, and then heating the binding fiber for melting to make 3 dimensional network. In such case, according to a double needle punching method, a needle penetrates from surface to inside of a sound-absorbing material during the molding process so that surface fibers are taken along with the needle, thus yielding a physical entanglement of the fibers to give a high-density sound-absorbing material made from polyester.

Polyester fiber, that is a main component of the above-described sound-absorbing materials, is produced by synthesizing, spinning, and drawing a polymer having an ester bond in backbone, and by carrying out other post treatment process for the polymer. Polyester fiber having high melting point (e.g., about 260-270° C.) that is typically used in the art is produced from a polymer which is obtained by esterification between terephthalic acid (TPA) or dimethylterephthalate (DMT) as a main acidic component and ethylene glycol (EG) and by polycondensation of a resulting ester. Meanwhile, polyesters having low melting point the same or less than 110° C. are produced from a polymer that is obtained by using isophthalic acid or phthalic acid as an acidic component. It is known that polyesters having high melting point are good in crystallinity while polyesters having low melting point have either poor or no crystallinity.

High-density sound-absorbing materials made from polyester have a relatively high soundproofing property, and therefore they have been used and modified in many ways. A sound-absorbing material having light weight characteristic, good sound-absorbing property, heat resistance, and compression resistance is disclosed in the publication of registered Korean Patent No. 10-0428286. Accordingly, in the same publication, a high-density sound-absorbing material made from polyester having a new structure, that is prepared by forming a composite laminate of three to five kinds of fiber webs that have been produced by using polyester fiber with high melting point as a main component and polyester fiber with low melting point a fixing or binding agent between fibers, is disclosed. Such sound-absorbing material is advantageous in that it can be easily shipped and applied at working site so that application cost is low and the material is recyclable, etc.

The above-described preparation method according to prior art involves laminating from one to three kinds of three-dimensional fiber web, which comprises in its internal layer a polyester fiber having high melting point that is formed by random carding, and further laminating mono-directional fiber web made of polyester fiber having low melting temperature on the top and bottom layer of said web, respectively, by directional carding process. Detailed process for preparing such laminate is given in the publication of registered Korean Patent No. 10-0428286. Because a porous, high-density polyester sound-absorbing material having a density from 150 kg/D to 350 kg/D is produced in a plate form using a ‘composite polyester fiber material’ as a basic material, in the pertinent art it is collectively referred to as ‘high-density polyester sound-absorbing plate’ or briefly ‘sound-absorbing plate’.

One advantage of such high-density polyester sound-absorbing plate is that it can be produced with a wide range of density including from 150 kg/D to 350 kg/D, so that its density is about five to eight times higher than that of conventional sound-absorbing materials. As a result, said sound-absorbing plate has a mechanical strength comparable to plywood, while still maintaining proper sound-absorbing property, low weight, flexibility, and easy processiblity, etc. Therefore, such sound-absorbing plate is being used not only for constructing a gym, an auditorium, a theater, and a church, etc. but also as a new sound-absorptive finishing material for interior design that can be used with or in place of ceiling plate, gypsum board, plywood, and MDF, etc. that are currently used in classrooms, offices, and educational institutes, etc.

Among said soundproofing properties of the high-density polyester sound-absorbing plate, the sound-absorbing property is accomplished via fine holes (i.e., thin holes) that are formed inside of the product. Accordingly, the presence of appropriate amount of fine holes inside the sound-absorbing board is essential to obtain a material with full soundproofing property. However, presence of such fine holes often causes a problem as they serve as a passageway for air, yielding an accumulation of pollution contained in the air and consequently bringing a serious damage to the appearance of the product. Until now, a temporary measure or mending process, etc. has been employed to deal with such problems. However, if not solved principally, they will remain as a big threat impairing life of the product.

When a sound-absorbing plate in a form of sound-absorbing or soundproofing material is applied to a structure, it is usually applied closely to wall face for adhesion. Depending on state of the wall face, an outcome of surface contamination may vary. For a wall face with even adhesive surface and no airflow over it, no problem would arise. However, when adhesive surface is not even, a space is formed between a sound-absorbing plate and the wall face due to the irregularity of the wall face. As a result, airflow constantly moves through said space and it may serve as an entrance for the outside air. In addition, after the lapse of a long period time since the application of a sound-absorbing plate to a wall face, a condition and a shape of the sound-absorbing plate and the wall face may change to generate above-described undesirable spaces.

Thus, aside from natural adhesion of dust in air, a fouling by serious contamination at part of the surface of a soundproofing (or sound-absorbing) material has constantly remained. In order to avoid such fouling, when a soundproofing (or sound-absorbing) material is applied, plywood or a gypsum board which can block airflow is often applied first to the wall and then the soundproofing (or sound-absorbing) material is applied.

However, even in such case, there is still some air which penetrates through a joint area of plywood or a gypsum board, causing dust pollution therein. To get around this problem, a pair of plywood or a gypsum board is applied in a staggered manner or vinyl tape, etc. is further used to block the air. However, this may lower working efficiency and when problems occur at hard-to-find regions or cement wall is cracked to form small gaps and spaces, there have been often many complaints made by consumers.

In this connection, in the publication of registered Korean Utility Model No. 20-0337828, a sound-absorbing material for preventing pollution by deposition of dust over time is disclosed, in which an adhesive is applied first and a paper is attached thereto. However, as it is explained in detail hereinafter, maintaining dust-proofing property and workability remained as a problem for said utility model. According to the publication of registered Korean Utility Model No. 20-0293784, which is owned by the same applicant as the one for the-above described Korean Utility Model No. 20-0337828, a sound-absorbing material that is prepared by a series of processes including, coating dust-proofing and water-repelling layer on the surface of non-woven fabrics, coating a flame retardant on the back side of the fabrics, carrying out an embossing process thereto and adding the resulting fabrics to a porous sponge substrate layer is described. Since a dust-proofing and water-repelling coating was carried out onto the non-woven fabrics instead of conventional fabrics, fouling by everyday pollution including water or oily substance, etc. can be efficiently avoided according to said utility model. However, air can still flow through them so that an accumulation of dust in air onto the surface of said waterproofing material cannot be avoided.

Recently, an inorganic, sound-absorptive ceiling plate (brand name; Mitone) is installed by hanging it over a metal frame of a ceiling so that workability and easiness for later fixing are improved. In this case however, a high-density polyester plate, which is excellent in sound-absorbing power, cannot be used for said installment involving hanging over ceiling due to its weakness to pollution.

### DETAILED DESCRIPTION OF ILLUSTRATIVE EMBODIMENTS

The method described in the above utility model is problematic in that it actually cannot be applied to a high-density polyester sound-absorbing plate. The reason is, since an adhesive is first added to the surface of a sound-absorbing plate and then heat is applied for adhesion, the resulting sound-absorbing plate can be warped in one direction when it is cooled due to a difference in heat shrinkage between the sheet and the sound-absorbing plate.

In addition, since papers used for preventing contamination are not stretchy, holes and tears can be easily made in the sound-absorbing plate during handling. To avoid such damages on the paper, certain thickness is required to maintain the strength of a kraft paper. In such case, however, when paper peeling occurs at a weak-bonded area, the damage can easily spread over the entire surface of the sound-absorbing plate. At the same time, materials that are used for producing the papers and the kraft papers placed between the sound-absorbing plate and the wall face tend to absorb moisture and solvent comprised in an adhesive applied to the walls, thus causing a weakening of the materials due to swell. This inevitably yields a decrease in adhesive strength.

Meanwhile, through the fine holes on the surface of a sound-absorbing plate, air can flow through the gaps of a gypsum board and the wall face to which the sound-absorbing plate is applied. As a result, dust contamination occurs. Further, the presence of fine holes on the backside of the sound-absorbing plate reduces the area that is available to be in contact with the wall face, and most of the adhesives become embedded into the uneven areas of the plate, making it difficult to maintain proper adhesive strength even when a great amount of the adhesives is applied thereto. Under the circumstances, not only a soundproofing property but also a sound-absorbing property and an easy workability are more and more required for a sound-absorbing plate. Accordingly, the present invention is to provide a composite sound-absorbing material having an anti-contaminating property and a good workability.

The reason consumers choose a high-density polyester sound-absorbing plate based on composite polyester fiber materials is that it has a sound-absorbing property and nice appearance. However, when problems described above occur, fine pores of the sound-absorbing board serve as a passageway not only for sound but also for air including dust. As a result, dust accumulates (filtering phenomenon) and a gap region will be soiled, yielding an unfavorable appearance.

Such contamination of the surface of the sound-absorbing plate is even worse when the plate is not completely adhered to a wall face. Because a high-density polyester sound-absorbing plate is densely packed and usually quite thin in its standard size, it often has a frequency bias which cause a drop in sound-absorbing property in a low frequency region.

Conventional low-density sound-absorbing materials have a rather low density and are used in a thickness of 25-50 mm. Thus, there is not much of difference in sound-absorbing property among various frequencies. However, for a high-density polyester sound-absorbing plate, at low frequency below 125 Hz (i.e., high wavelength region), a sound-absorbing effect is hardly observed. For such reasons, when a high-density polyester sound-absorbing plate is installed in a piano room in an apartment complex, a base booming phenomenon occurs typically.

To improve a sound-absorbing power at base region, an air layer is introduced by providing a space about 50 mm wide between a wall face and a sound-absorbing plate. As a result, in response to base sound the high-density polyester sound-absorbing plate vibrates and absorbs a sound energy transformed into a kinetic or heat energy. Sound-absorbing property at base region is therefore improved.

Measuring a sound absorption coefficient in a reverberation room (i.e., KS F 2805), which is a general method to estimate a sound-absorbing property of a sound-absorbing material, was carried out and the results are given in Table 1 below. The high-density polyester sound-absorbing plate was applied either directly (Sample 1) or with a space of 50 mm wide (Sample 2) against the wall face, respectively, and their sound-absorbing property was compared to that of the low density sound-absorbing material (Sample 3). It was found that the sound-absorbing property of the high-density polyester plate that is 9 mm thick and applied with 50 mm air layer against the wall face is similar to that of the 25 mm thick, low density sound-absorbing materials.

TABLE 1

| | 9 mm, | 9 mm, | 25 mm, |
|---|---|---|---|
| Frequency | 230 Kg/m3 | 230 Kg/m3/air layer | 60 Kg/m3 |
| (Hz) | (Sample 1) | (Sample 2) | (Sample 3) |
| 250 | 0.02 | 0.27 | 0.27 |
| 500 | 0.12 | 0.46 | 0.52 |
| 1000 | 0.36 | 0.70 | 0.68 |
| 2500 | 0.67 | 0.73 | 0.71 |

Installing a high-density polyester sound-absorbing plate after securing an air layer is effective for improving processes at work place for interior designing and reducing the amounts of materials being used. Conventional works usually involve an installment of a frame using timber, applying plywood and gypsum board and then adding a sound-absorbing material thereto. However, when a high-density polyester sound-absorbing plate is applied with a secured air layer, it can be directly applied onto the timber frame. When a piano room in an apartment complex is constructed in that way, i.e., timber frames are applied onto existing wall face and then a high-density polyester sound-absorbing plate is applied thereto, the sound-absorbing property in base region is improved.

Unfortunately, however, contamination still occurs on the surface of the sound-absorbing plate. Except the area attached the frame, the contamination occurs most of the region contacting air, eventually revealing the shape of the timber frame.

The same phenomenon occurs when a high-density polyester sound-absorbing plate is installed in ceiling. Recent ceiling works generally involve suspending a metal frame in the ceiling and hanging ceiling materials (Tex) over it or fixing them with screw nails. However, three to six months after the application of the high-density polyester sound-absorbing plate to existing ceiling materials, contamination on the surface of the sound-absorbing plate occurs along the joint region of Tex and it is easily noticed.

In order to solve the above-described problems, inventors of the present invention carried out various tests. First, to prevent a filtering phenomenon regardless of the state of surface to be adhered, a windshield is formed on the sound-absorbing plate. Specifically, an adhesive-treated paper was applied to the backside of the plate by ironing. As a result, said filtering phenomenon was improved but the product shrunk and got warped upon cooling. Thus, it is not suitable for practical use. Alternatively, in order to prevent the adhesion of dust on a surface of a sound-absorbing plate, a calendaring process was carried out using a heat press for smooth surface. However, after lapse of the time, the filtering phenomenon still remained. After experiencing many difficulties for developing a method which satisfies good workability, economical efficiency and commercial interest, inventors of the present invention finally developed the sound-absorbing composite materials which have a good anti-contamination property and workability.

More specifically, in order to solve the above-described problems of prior art, the present invention provides a high-density sound-absorbing composite material made from polyester comprises a porous sound-absorbing material which is based on composite polyester fiber materials having a density from 150 kg/D to 350 kg/D and a synthetic resin that is attached to one side of said base material. According to the present invention, any commercially available high-density polyester sound-absorbing plate having no synthetic resin sheet attached thereto can be used as it is for sound-absorbing base material. However, in order to differentiate it from the inventive sound-absorbing composite materials, all kinds of fiber materials including said high-density polyester absorbing plate that can be used for the present invention is generally referred to as ‘sound-absorbing base material’.

According to the present invention, said sound-absorbing base material is 3-20 mm thick and said synthetic resin sheet is anyone preferably chosen from a vinyl, PET and OPP (oriented polypropylene). Such synthetic resin sheet functions as a windshield blocking breathability of the fine pores of the sound-absorbing base materials so that contamination can be prevented.

According to another embodiment of the present invention, a sheet made from a hot melt adhesive material having low air permeability by hot-melt and extrusion processes can be used instead of said synthetic resin sheet so that the adhesive sheet itself functions as a windshield. With a similar principle, when a synthetic resin sheet having low melting point is hot-melt bonded to polyester fibers having low melting point that are present in the synthetic resin sheet or the sound-absorbing base materials, an adhesive effect as well as a windshield effect can be simultaneously obtained.

Furthermore, the sound-absorbing composite material of the present invention may additionally comprise an adhesive layer having a high amount of solid component which is thick enough to prevent air penetration, between said sound-absorbing base material and said synthetic resin sheet. In such case, the synthetic resin sheet serves as a release liner and is removed at the time of actual application. In addition, over a vinyl sheet of high-density polyester sound-absorbing composite material to which said synthetic resin sheet is attached, a coated adhesive layer and a release liner can be further comprised to replace a process of applying adhesives at the time of actual application.

According to another embodiment of the present invention, a sound-absorbing composite material made from high-density polyester, wherein various patterns for obtaining an advertising effect are printed on the external face of said sheet or said release liner, can be provided.

According to another embodiment of the present invention, the external face of said sound-absorbing base material is coated with fluorochemicals before being bonded with the synthetic resin sheet or, after bonding with the sheet the remaining external face of the sound-absorbing base material that has not been bonded can be coated with fluorochemicals. In addition, the present invention provides sound-absorbing composite materials made from high-density polyester wherein fluorochemicals are coated on either one or both faces of the base material.

According to still another embodiment of the present invention, the present invention provides an apparatus for producing high-density sound-absorbing composite materials made from polyester by which a synthetic resin sheet is bonded to said sound-absorbing base materials, characterized in that the apparatus comprises the following means;
(1) a means for inserting sound-absorbing base materials between on a flat working board and under the sheet while the revolution speed of a supporting roller on which said sheet is wound is being controlled,
(2) a means for fixing both corners of said sheet by pulling them to make the sheet align with the edge of said sound-absorbing base material, and
(3) a means for adhering said sheet tightly to said sound-absorbing base material by rotational motion of said roller.

The apparatus of the present invention may further comprise (4) a means for adhering a release liner so that the release liner can be additionally bonded to the external face of said sheet that is adhered to said sound-absorbing base material. Moreover, in order to achieve an intimate bonding of said sheet to said sound-absorbing base material by rotational motion of said roller, it is preferable to maintain the angle between said roller and said sound-absorbing base material to be about 90 degrees.

FIG. 1 is an illustration showing the high-density sound-absorbing composite materials made from polyester according to the present invention. FIG. 2 is an illustration of one embodiment of high-density sound-absorbing composite materials made from polyester of the present invention in which a company logo is printed on a release liner which has been adhered to an external face of said sound-absorbing composite material. With reference to these figures, the present invention will be explained in detail herein below.

According to FIG. 1, the sound-absorbing composite material of the present invention 10 consists of said commercially available sound-absorbing base material 20 and a synthetic resin sheet 40 which is adhered to one surface of said base material via first adhesive layer 30 with an aid of adhesives.

The sound-absorbing base material 20 that is used in the present invention is a high-density polyester sound-absorbing plate which has been produced using commercially available composite polyester fiber materials as a base material. When such sound-absorbing plate is produced in accordance with the method described in the publication of registered Korean Patent No. 10-0428286, layers of the fibers should be separated and a carding machine is required therefor. Thus, it can be unfavorable in economical point of view. Particularly, as high-density polyester sound-absorbing materials are used for interior design, their color quality as well as homogeneous blend of fibers becomes more important so that commercialization of the method described in said prior art is rather difficult.

Considering the above, based on a composite polyester material which is formed by mixing polyester fibers having high melting point as a main material and polyester fibers having low melting point and then aligning evenly the resulting mixture with a carding machine, high-density polyester sound-absorbing materials having density from 150 kg/D to 350 kg/D can be produced. Moreover, a product named Art board (trade name) having density of 230 kg/D and thickness of 9 mm can be also used.

Commercially available Art board having a determined size of 1220×2420×5-20 mm (W×L×H) is generally used. However, if necessary, it can be cut into a small size and a resulting piece with a divided dimension can be also used. Especially, the density of the sound-absorbing base material 20 is from 150 kg/D to 350 kg/D considering the porous character of the material. Said sound-absorbing base material 20 is sometimes referred to as soundproofing material depending on a user and according to the present invention it is used to include such soundproofing material.

The thickness of said sound-absorbing base material is preferably of between 3 and 20 mm when a product having the same density is produced in terms of the thickness of a typical sound-absorbing or soundproofing plate. If it is thinner than said range, sound-absorbing effect cannot be obtained. On the other hand, if it is thicker than said range, adequate strength of the plate cannot be obtained and the appearance and workability of the plate can be problematic.

An adhesive which is used in the present invention to constitute first adhesive layer 30 can be any industrial adhesive or hot-melt adhesive sheet that can bond said polyester fibers to the synthetic resin with certain strength.

In addition, the synthetic resin sheet 40 used for the present invention can be made from either a thermoplastic resin including crystalline polyethylene, nylon, polyacetal resin and non-crystalline vinyl chloride resin, polystyrene, ABS resin, acryl resin, PET, and OPP (oriented polypropylene), etc. or a thermosetting resin including melamine resin, phenol resin and urea resin, etc. Considering the workability, adhesion property and price, etc. of the sound-absorbing plate, it is preferably selected from vinyl, PET and OPP. Moreover, a vinyl tape having an adhesive applied on one or both faces of the tape can be used, which eliminates the use of an adhesive consisting of the above-described first adhesive layer 30. An appropriate size of such tape may vary depending on the size of the sound-absorbing base material. When a regular sound-absorbing plate is used, a tape that is 1220 mm wide, at least 50 m long and packed in a roll can be used. Depending on specific use, its size can be appropriately adjusted.

Meanwhile, when a vinyl tape is directly bonded to the sound-absorbing base material during the manufacturing process of the tape, production cost can be saved thanks to the reduction of the number of steps for manufacturing.

Depending on the thickness of the above-mentioned sound-absorbing base material 20 thickness of the synthetic resin sheet 40 and first adhesive layer 30 will be decided. When the thickness of the sound-absorbing base material 20 is within the range of 3-20 mm, the thickness of the synthetic resin sheet 40 and first adhesive layer 20 is preferably within the range of about 0.02 mm to 5 mm.

Meanwhile, a sheet made from a hot melt adhesive material having low air permeability by hot-melt and extrusion process can be used instead of said synthetic resin sheet. Such hot-melt adhesive sheet is an adhesive sheet that is produced by hot-melting a thermoplastic resin, extruding it in a form of sheet, and reheating the resulting sheet to obtain adhesiveness. It is made from thermoplastic urethane which is not toxic to human body and has an excellent adhesiveness. In addition, it has an improved adhesion quality with homogeneous adhesiveness that is not expected from conventional liquid-type adhesives. Various types of hot-meal adhesive sheets are now on market but anyone made from polyolefin groups can be properly chosen and used. Use of such hot-melt sheet eliminates a need for a separate vinyl sheet or a release liner, making the working process more convenient and easy.

When a hot-melt adhesive sheet is used as a synthetic resin sheet, it is preferable to carry out hot pressing of the sheet in a speed of 5 m/min at 140° C. Under said heating condition, the sound-absorbing plate would not be warped and excellent adhesion can be obtained so as to prevent a separation between the sound-absorbing base material and the synthetic resin sheet after their application to wall face.

If the melting point of a synthetic resin sheet instead of an adhesive sheet is close to that of a polyester fiber having low melting point, heat penetrating the synthetic resin sheet can melt down the polyester fiber having low melting point, resulting its melt-adhesion to the synthetic resin sheet. Synthetic resin sheet that is proper for such use includes EVA and PE having a melting temperature the same or less than 120° C.

For the sound-absorbing composite material of the present invention 10, an adhesive layer having certain thickness 30 can be used in place of the synthetic resin sheet 40 to bond the sound-absorbing base material 20 to the synthetic resin sheet 40. In such case, the adhesive layer is prepared to have a thickness that can prevent air penetration through the sound-absorbing base material so that a filtering effect can be improved even with out a synthetic resin sheet. Such adhesive layer can be produced by coating the backside of the sound-absorbing base material with a typical adhesive component such as rubber latex, etc. having adhesiveness and a high solid content and further applying a vinyl sheet as a release liner thereto. Upon its actual application onto wall face, the vinyl sheet can be simply removed for a convenient use. Because the adhesive layer may function as a windshield, an anti-contamination effect can be obtained. Thickness of the adhesive layer may vary depending on the material, but can be usually within the range of about 0.02 mm to 5 mm.

Another embodiment of the present invention will be explained in view of FIG. 2. According to FIG. 2, another sound-absorbing composite material of the present invention 10 consists of the above-described sound-absorbing base material 20, a synthetic resin sheet 40 that has been applied to one side of the base material by the adhesive of first adhesive layer 30, second adhesive layer 35 formed on the exposed face of the resin sheet 40, and a release liner 50 added onto said second adhesive layer. Said second adhesive layer 35 is present on the synthetic resin sheet 40 that is attached to the sound-absorbing base material 20. The synthetic resin sheet 40 prevents the penetration of the adhesives towards the sound-absorbing base material 20 and increases a portion of the area which can participate in the adhesion. Thus, the adhesiveness and the workability of the sound-absorbing composite material 10 of the present invention can be improved. Unlike first adhesive layer 30, second adhesive layer 35 may consist of a latex-type industrial adhesive, which does not solidify with lapse of the time. Further, the release liner 50 protects the adhesive layer 35 of the composite material until it is used by consumers. As explained above, thickness of first adhesive layer 30 and second adhesive layer 35 may vary depending on use of the composite material of the present invention, but can be appropriately within the range of about 0.02 mm to 5 mm, respectively.

The release liner 50 used in the present invention can be any paper release liner that is used generally in the art. It includes Kraft release liner and Glassine release liner. Glassine, which has a good mechanical strength and favorable surface smoothness, is more preferable in that it can be directly used for a silicone treatment.

According to another embodiment of the present invention, on an exposed face of the synthetic resin sheet 40 that is bonded to the sound-absorbing composite material 20 of the present invention or on an exposed face of said release liner 50, an advertising description 55 can be printed. The advertising description 55 can be anyone for advertising the sound-absorbing composite material or for increasing its commercial value by including product logo or grid pattern, etc. The advertising description 55 can be printed on the synthetic resin sheet 40 before or after the resin sheet is bonded to the sound-absorbing base material 20. It is preferable to print before the bonding.

Meanwhile, inventors of the present invention studied and carried out experiments for using fluorochemical polymers or fluorochemicals in the present invention. It is based on the fact that the fluorochemicals have water-repellency, oil-repellency, anti-contamination property, and endurance so that they are highly valuable in fiber processing.

After numerous trial and error, inventors of the present invention found that when the fluorochemicals are coated on the surface of sound-absorbing base material that is based on high-density polyester sound-absorbing fibers, adhesion of contaminants such as oils, etc. that can be attached to the surface of the sound-absorbing composite materials in everyday life can be reduced, and therefore completed another embodiment of the present invention.

In order to increase the endurance of said coated, sound-absorbing composite material, it is important to enhance adhesion between the layer coated with water-repelling (or anti-contaminating) fluorochemicals and polyester fibers. Forces acting between the fibers and the coating layer include an intermolecular force (van der Waals forces) and a chemical bonding force. The intermolecular force is responsible for the water-repellency and anti-contaminating property of the flluorochemical coating that is treated to the fibers. It is believed that fluorine-containing perfluoroalkyl group (i.e., ester group) is aligned with the fibers at a right angle to contribute to water-repellency and anti-contamination property, while acrylic acid group, which is a backbone of the fluorochemicals, contributes to the adhesive bonding to the fibers. In addition, since inorganic/organic value of the adhesive portion is most similar to that of polyester among fiber materials due to said intermolecular force, it is believed that the coating layer of fluorochemicals adheres to polyester and provides a good endurance.

Such fluorochemicals were first developed by 3M Company, USA in 1956 (i.e., Scotchguard). Since then, many similar products are developed and sold by companies like Dupont, Penwelt Allied, Ciba-Geigy, Asahi Glass, and Daikin, etc., and any of their products can be used for the present invention. Further, for a process to treat the surface of polyester fibers with the fluorochemicals, three general methods can be mentioned, i.e., padding, gravure and spray method. Among them, the padding method is the best in that it provides a coating over the entire surface of the fiber so that water-repellency and anti-contaminating effect are good. However, backside of the sound-absorbing plate can be also given with water-repellency by padding method, therefore possibly lowering its adhesiveness when it is applied to a wall face.

Meanwhile, according to a gravure method a coating layer that has been transported through two rolls is applied to only one side of a sound-absorbing base material. Because on the backside of the material no water-repelling or anti-contamination treatment is given, it is preferable to prepare a sound-absorbing plate which requires water repellency at one side only. Spray method is similar to a gravure method in that only one side of the plate is treated. For the present invention, a water-repelling or anti-contamination treatment is carried out by gravure method or spray method. A method known as Teflon coating by Dupont Co. can be also used. After the coating, setting and drying steps are carried out to set the fluorochemicals on the surface of the sound-absorbing base material made from high-density polyester, eventually yielding a complete fluorine coating.

Another embodiment of the present invention wherein said coating with fluorochemicals is introduced will be explained in view of FIG. 3. According to FIG. 3, the sound-absorbing composite material of the present invention 10 consists of the above-described sound-absorbing base material 20, the synthetic resin sheet 40 that has been applied to one side of the base material by the adhesive of the first adhesive layer (30), and the coating layer of fluorochemicals 60 that is applied on the exposed face of the sound-absorbing base material 20. For forming the fluorochemical coating layer (60), an external face of said sound-absorbing base material can be coated with fluorochemicals before said synthetic resin sheet 40 is attached to the base material, or after the attachment of the resin sheet fluorochemicals are coated to an exposed face of the base material, and then setting and drying processes can be carried out. Moreover, depending on the needs of consumers, said sound-absorbing base material (20) can be coated with the fluorochemicals and then sold without the synthetic resin sheet attached thereon.

Finally, the production method of the present invention can be briefly summarized as having steps of spraying an additional adhesive to the backside of the sound-absorbing base material and then bonding the synthetic resin sheet or commercially available vinyl tapes (e.g., Scotch tape) thereto by pressing. Because such method can be carried out at ambient temperature without heating, any deform of the plate can be prevented in general circumstances.

Meanwhile, specific processes of the method of the present invention can be explained in view of FIG. 4 which briefly illustrates an apparatus for manufacturing the sound-absorbing composite material of the present invention.

First, on a lathe of an apparatus for taping adhesion 80, the above-described sound-absorbing base material (W×L×H dimension; 1220×2420×5-20 mm) 20 is placed in a way that a vinyl tape can be bonded to the backside of the plate, after identifying the front and backside of the plate, respectively. Next, a sheet roll 77 carrying vinyl tape (1210 mm wide and at least 50 m of the tape is wound in a roll) 45 is inserted into the sheet roller 81 and fixed so that it cannot slide sideways when the roller is in motion.

Then, the taping machine is switched on and the sound-absorbing base material 20 is inserted manually all the way to the adhesion point for the tape while appropriately controlling the revolution speed of the machine. The end of the vinyl tape is pulled by hands so that it can be hanged on a guide roller (not shown), and then adhered to the sound-absorbing base material 20 so that it can be at the center of the end region of the material. A caution has to be taken to make the longitudinal directions of a product and the vinyl tape the same and parallel to each other while the vinyl tape 45 is placed without being crinkled. Meanwhile, with respect to the guide roller, its screw threads are adjusted so that they all point to the center region in a rotational direction so that the sheet can be flattened out, as the roller starts moving. As a result, the vinyl tape can be evenly spread as it moves through the guide roller.

Next, when the sound-absorbing base material 20 is pushed by hands towards the roller so that the top roller 71, the bottom roller 73 and the sound-absorbing base material 20 are all at a right angle from each other, the vinyl tape 45 is applied on top of the sound-absorbing base material 20 via rotational motion of the roller. While being careful not to distort the sound-absorbing base material 20 while it is being transported, next sound-absorbing base material is prepared to be in line. The bottom roller 73 is pushed to work by a motor connected thereto, and on its surface an uneven pattern is formed to prevent a sliding. Meanwhile, the top roller 71 is prepared as a free-rotational roller which is put into motion by frictional forces with the sound-absorbing base material 20 that moves along the rotation of the bottom roller 73. Furthermore, for the case of employing synthetic resin sheet 40 the top roller 71 can be equipped with an internal, rod-shaped heater (not shown) in connection with a control box (not shown) that can adjust the temperature in the range of 70-200° C., if necessary.

In such case, before the two thirds of the vinyl tape 45 are bonded to the sound-absorbing base material 20, the resulting product is pushed strongly towards the roller so as to prevent any gap between the product and a sound-absorbing base material to be processed next. As a final step, while being careful not to loose the joint region form the roller, the pushed-through product and a new product being taped are separated by cutting them along the joint region using a cutting knife.

When the synthetic resin sheet 40 is used instead of a vinyl tape and an adhesive is sprayed thereto, two nozzles 75 that move side to side between the sound-absorbing base material 20 and the vinyl sheet are conveniently installed so that press-adhesion can be carried out by using the top and the bottom roller 71 and 73, respectively, while the adhesive is sprayed from the nozzles 75 with a constant rate. In this case the nozzles 75 are forced to move back and forth so that they can spray the adhesive in the horizontal directions of the sound-absorbing base material 20 and the resin sheet 40. Compressed air is used for spraying the adhesive.

If an adhesive is first coated on the synthetic resin sheet 40 and then the resulting sheet is bonded to the sound-absorbing base material 20, a step for processing with the adhesive tape can be simplified and thus the production cost can be saved.

When a release liner is desired on the surface of the above-described vinyl sheet that has been attached to the sound-absorbing base material, an additional apparatus for adhesion can be installed to said taping machine, or the sound-absorbing base material to which the vinyl sheet has been previously attached can be fed again to the apparatus for adhesion. In such case, an adhesive having a reproducible adhesive property is sprayed via nozzle, a release liner roll is installed in a roll for supporting the vinyl sheet, and then the release liner is adhered thereto with the same manner to prepare the high-density polyester sound-absorbing composite material with desired features.

The high-density polyester sound-absorbing composite material according to the present invention wherein a synthetic resin sheet is attached to one side of the material, was evaluated in the following examples with respect to air permeability and anti-contaminating property in relation to water-repellency (i.e., a resistance to surface wetting) and oil-repellency.

### EXAMPLES

### Example 1

### Air Permeability Test

First, a high-density polyester sound-absorbing plate (9 mm thick) was purchased from a manufacturer. A common adhesive (HU-4291-40) was applied (45 D thick) to the backside of the sound-absorbing plate. A part of the resulting plate was used as it is as Specimen No. 4 (600×600 mm) and the remaining plate was used to prepare Specimen No. 5 (600×600 mm) wherein PET synthetic resin sheet SP101 (manufactured by Hwasung Industries) was additionally applied (38 micrometer thick) to the plate.

Air permeability (i.e., level of air penetration through the holes of fabrics) test was carried out for said Specimen Nos. 4 and 5 according to Korean Standards No. KS K 0570:2001 under the test pressure of 200 Pa. Results are given in the following Table 2.

TABLE 2

| | Commercial product | Specimen | Specimen |
|---|---|---|---|
| | as a control | No. 4 | No. 5 |
| Air | 58.7 | 40.3 | 0.1 or less |
| permeability | | | |
| (cm 3/cm 3/s) | | | |

As it is shown in the above experimental data, air permeability for the sound-absorbing composite material of the present invention wherein an adhesive and a synthetic resin sheet have been applied is significantly lower than that of the sound-absorbing plate having no such adhesive and resin sheet (i.e., commercially available plate as a control). When Specimen No. 5 was applied to a ceiling having an air-mediated contamination, it was confirmed that no air-mediated contamination has occurred even after six months when contamination starts to develop in general.

### Example 2

### Evaluation of an Anti-Contamination Property

To the sound-absorbing plate used in the above Example 1 (i.e., commercially available product as a control), 5% aqueous solution of an anti-contaminating agent (e.g., stain resistant agent, PHOBOTEX AMS, HUNTSMAN) was coated to the level of 210 g/D and then the plate was moved at the speed of 5 m/min at 150-160° C. for thermosetting. As a result, Specimen No. 6 was obtained. The specimen was first cut into a size of 300 mm×300 mm and sent to a test center. The test was carried out as prescribed in the Korean Standards. In order to evaluate a surface-protecting property of the plate, water-repellency and oil-repellency were measured, respectively.

(1) Water-repellency is a property of fabrics resisting water permeation and it is generally tested by a well-established Spray method. Water repellency is evaluated based on a score rating (e.g., from 1 to 5 scale) by Korean Standards KS K 0590:2001. Specifically, scores are given according to the evaluation criteria as follows: 1 (front and back surfaces of fabrics are completely wet), 2 (front surface is partially wet), 3 (watered area is wet only), 4 (a little wetting or adhesion occurs on surface), 5 (no wetting or adhesion occurs on surface).

(2) Oil-repellency is a property of fibers or fabrics resisting wetting by an oily liquid. Lower the surface energy of surface, oil repellency is higher for that material. By treating with fluorochemicals a material can be endowed with oil-repellency. Oil-repellency is evaluated by Korean Standards KS K 0526:2001 with a sequential selection of the hydrocarbon solution having a different surface tension and a determination of a resistance to the hydrocarbon oil absorption by fibers or fabrics. To the specimens prepared, at least five drops of the standard test solutions having oil repellency scores of from 0 to 8 were added starting from the solution having the lowest score. As a result, the test solution having the highest score that did not wet the specimen is identified and the score corresponding to said highest test solution is given as an oil repellency for that specimen. The results are given in the following Table 3.

TABLE 3

| | Commercial product | Specimen |
|---|---|---|
| | as a control | No. 6 |
| Water repellency | 2 | 4 |
| Oil repellency | 0 | 6.0 |

Numbers given in the above test result represent the score level. A higher score level corresponds to a better performance. As it is shown in the above table, the score level of Specimen No. 6, which is a sound-absorbing composite material coated with an anti-contaminating agent according to the present invention, has a better water-repellency and oil-repellency than those of the non-coated sound-absorbing plate (i.e., commercially available product as a control), i.e., water repellency score was two levels higher and oil repellency score was six levels higher than those of the non-coated sound-absorbing plate, respectively. In addition, it has been also confirmed that the sound-absorbing composite material coated with an anti-contaminating agent according to the present invention is resistant to everyday contamination including coffee and food oil, etc.

Taken together the above-described data indicating the water-repellency and the oil-repellency, it is confirmed that the sound-absorbing composite material according to the present invention even has an improved anti-contaminating property.

### BRIEF DESCRIPTION OF THE DRAWINGS

FIG. 1 is an illustrative drawing of the sound-absorbing composite material made from high-density polyester according to the present invention.

FIG. 2 is an illustrative drawing of the sound-absorbing composite material made from high-density polyester corresponding to one embodiment of the present invention, wherein a company logo is printed on the exposed face of the release liner that is attached to the composite material.

FIG. 3 is an illustrative drawing of the sound-absorbing composite material made from high-density polyester corresponding to another embodiment of the present invention, wherein the composite material is coated with fluorochemicals to provide an anti-contaminating layer.

FIG. 4 is an illustration showing the apparatus for adhering a vinyl sheet to the sound-absorbing composite material according to the present invention.

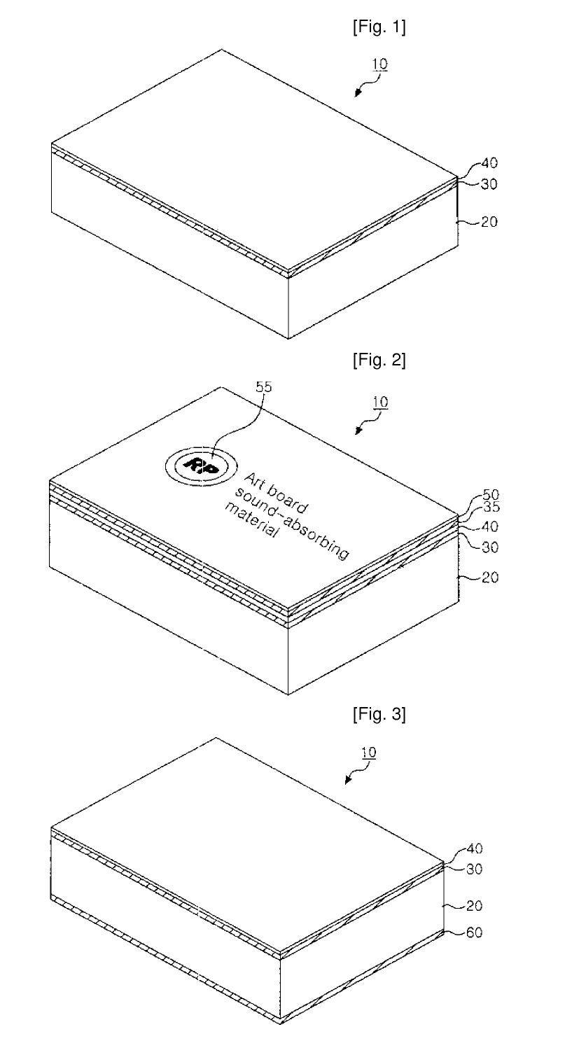

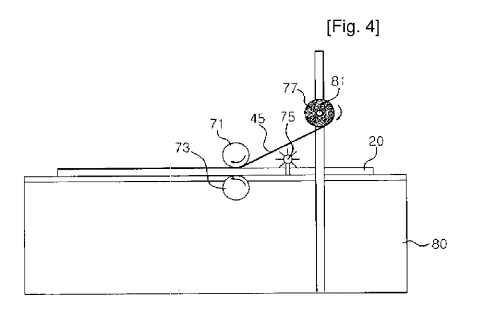

### INDUSTRIAL APPLICABILITY

Embodiments of the present invention aim to block air flow through the wall face while maintaining porosity for soundproofing (sound-absorbing) effect by adhering tightly a thin synthetic resin sheet to backside of a high-density polyester sound-absorbing plate. According to the present invention, even when a gap is present between a sound-absorbing plate and a wall face due to the irregularities of the wall face and protrusion of foreign materials, etc., the sheet adhered to the backside of the sound-absorbing plate would block air flow. Therefore, adsorption of dust in certain direction can be avoided.

Furthermore, since the sound-absorbing material of the present invention is provided with anti-contaminating and water-repelling effects, it is expected that a common contamination not only by dust but also by oily substances, etc. can be avoided. Considering that most of the conventional sound-absorbing plates get rapidly contaminated so that their actual usage time is shortened and an extra cost is required for re-construction of a wall face, it is clear that the sound-absorbing composite material of the present invention, which can avoid such problems, is industrially very useful.

What is claimed is:

1. A high-density sound-absorbing composite material, comprising a porous sound-absorbing base material which is based on composite polyester fiber materials having a density of from 150 kg/D to 350 kg/D and a synthetic resin sheet that is attached to one side of said base material.

2. The high-density sound-absorbing composite material according to claim 1, characterized in that said sound-absorbing base material is 3-20 mm thick and said synthetic resin sheet is anyone chosen from vinyl, PET and OPP (oriented polypropylene).

3. The high-density sound-absorbing composite material according to claim 1, characterized in that said synthetic resin sheet is (1) a sheet made from a hot melt adhesive material having low air permeability effected through hot-melting and extrusion processes, or (2) a synthetic resin sheet having low melting point so that with heat pressure it can be adhered to said sound-absorbing base material.

4. The high-density sound-absorbing composite material according to claim 1, characterized in that between said sound-absorbing base material and said synthetic resin sheet an adhesive layer having a thickness of from 0.02-5 mm is further comprised to prevent air penetration.

5. The high-density sound-absorbing composite material according to claim 4, characterized in that in addition to said adhesive layer that is adhered to said synthetic resin sheet a release liner is further comprised.

6. The high-density sound-absorbing composite material according to of claim 1, characterized in that the external face of said sound-absorbing base material made from high-density polyester is coated with fluorochemicals before said adhesion by synthetic resin sheet, or after the adhesion the other external face which is not adhered with synthetic resin sheet of said sound-absorbing base material made from high-density polyester is coated with fluorochemicals.

7. The high-density sound-absorbing composite material according to claim 2, characterized in that the external face of said sound-absorbing base material made from high-density polyester is coated with fluorochemicals before said adhesion by synthetic resin sheet or after the adhesion the other external face which is not adhered with synthetic resin sheet of said sound-absorbing base material made from high-density polyester is coated with fluorochemicals.

8. The high-density sound-absorbing composite material according to claim 3, characterized in that the external face of said sound-absorbing base material made from high-density polyester is coated with fluorochemicals before said adhesion by synthetic resin sheet or after the adhesion the other external face which is not adhered with synthetic resin sheet of said sound-absorbing base material made from high-density polyester is coated with fluorochemicals.

9. The high-density sound-absorbing composite material according to claim 4, characterized in that the external face of said sound-absorbing base material made from high-density polyester is coated with fluorochemicals before said adhesion by synthetic resin sheet, or after the adhesion the other external face which is not adhered with synthetic resin sheet of said sound-absorbing base material made from high-density polyester is coated with fluorochemicals.

10. The high-density sound-absorbing composite material according to claim 5, characterized in that the external face of said sound-absorbing base material made from high-density polyester is coated with fluorochemicals before said adhesion by synthetic resin sheet, or after the adhesion the other external face which is not adhered with synthetic resin sheet of said sound-absorbing base material made from high-density polyester is coated with fluorochemicals.

11. An apparatus for producing a high-density sound-absorbing composite material made from polyester, wherein by using said apparatus a synthetic resin sheet is adhered to a high-density and porous sound-absorbing base material which is based on composite polyester fiber materials, wherein said apparatus comprises means:
(1) a means for inserting sound-absorbing base materials on a flat working board and under the sheet while the revolution speed of a supporting roller on which said sheet is wound is being controlled,
(2) a means for fixing corners of said sheet by pulling them to make the sheet align with the edge of said sound-absorbing base material, and
(3) a means for adhering said sheet tightly to said sound-absorbing base material by rotational motion of said roller.
